(19) United States
(12) Patent Application Publication
(10) Pub. No.: US 2007/0237337 A1
(43) Pub. Date: Oct. 11, 2007

(54) Modular speaker system

(76) Inventor: Pat Y. Mah, Kowloon (HK)

Correspondence Address: Curt Harrington, Suite 250, 6300 State University Drive, Long Beach, CA, 90815, US

(21) Appl. No.: 11/399,015

(22) Filed: Apr. 5, 2006

(51) Int. Cl. H04B 3/00; G05B 11/01

(52) U.S. Cl. 381/77; 340/310.11

(57) ABSTRACT

A flexible speaker system utilizes the AC mains connection as a transmission medium to distribute an audio signal throughout any building or set of buildings having power associated with the AC mains circuit, as well as electromagnetic space wave and optical communications. The key to the flexibility of the system is its inexpensiveness coupled with automatic balancing and control features. Features include automatic balancing, automatic channel control, portability, add-on system components with identification and distributed control.

### FIELD OF THE INVENTION

The present invention relates to audio equipment and particularly to speakers which have features which eliminate the mess and labor involved in a custom installation, and which can have additional units added by simply plugging them into the household AC mains receptacle.

### BACKGROUND OF THE INVENTION

The ability to use speakers systems have always included a good deal of wire usage and hiding, splicing and interconnection. Much of the labor and problems with speakers comes with the improvement from a one speaker device to a two speaker device. Better listening comes from separation of the second speaker and with it the extra wire, wire support and fuss that comes with providing a second speaker. Additional speakers can be added, but for each speaker another wire set is required, as well as extending the wire to the speaker's location.

Once a decision has been made to upgrade to a high quality system, the price increases sharply but the commitment to wiring extensions, supports and wire hiding has already occurred. However, in terms of listening enjoyment and utility, the most significant is the addition of the second, third, fourth, etc. speakers. If speakers could be added without the necessity to cut, add and splice wiring, significant barriers to the increased enjoyment from greater numbers of speakers could be obtained.

Another problem is the planning needed for positioning. Some high end speaker systems realize how critical placement can be to obtain the last best percentage of quality from an already sophisticated and expensive speaker system that they include special stands support and orient the speakers. As a result, having one of these types of systems installed is not only expensive in terms of the equipment, but also in terms of installer time and room customization. In many cases systems are selected to fit a particular room. Further, once these systems are installed, they cannot be practically be moved from room to room, nor can they be expanded into other rooms and separate buildings.

### SUMMARY OF THE INVENTION

A flexible speaker system utilizes the AC mains as a transmission medium to distribute an audio signal throughout any building or set of buildings having power associated with the AC mains circuit. The key to the flexibility of the system is its inexpensiveness coupled with automatic balancing and control features. An analog transmission and demodulation system with filtering provides quality sound through the AC mains without having to connect specialized wires or coaxial cable. The speaker system will have at least one of the speaker units which is or can be designated as a master speaker. The master speaker has the ability to detect and balance the output signals by their volume and location, select stereo channel levels for speakers and to detects noise levels in the AC mains line. Response to noise can include filter selection and transmit/receive frequency selection and mode to minimize the noise level by scanning and trying frequencies which have the least amount of noise. The modes of communication can be electromagnetically through the AC mains, Electromagnetically via radio wave, or optically via an infrared link where the speakers are in an effective visual proximity. Ideally, all of the speaker units will have manual overrides and some independent control which can be selected by the user.

The flexible speaker system, through its controls, can overcome the effects of location in various AC mains outlets by providing time domain sensed balancing, both for volume and stereo channel selection. The master speaker will be able to determine the relative distances of all speakers in the system and may automatically assign stereo channel and volume values to the other speakers to provide a “surround” effect. Where the speakers are placed in different rooms, one of the room speakers may be designated as a volume and stereo balancing speaker for that room. The result is the ability for a user to add modular speakers throughout the home, perhaps one at a time, to inexpensively acquire substantially the same effect as a professionally installed, in-home speaker system.

Volume balance can be accomplished via a “tic” or “pop” sound from a designated volume master speaker at a given volume, followed by a similar sound in sequence from the other speakers. The master speaker and other speakers have a microphone to detect the sound, which could be within or outside the audible range. Once the volumes received by the two speakers was the same, the master speaker would know the relative sound level to set the other speaker(s).

Volume balance and delay can also be based upon time domain reflectometry. A “tic” output from the main or master speaker can be detected by one of the other speakers and sent back to the main speaker along with its identity. The main speaker will be able to calculate the total delay based upon the time to form a communication loop through the AC mains (where it communicates electromagnetically) and via a complete sound and electromagnetic cycle. Thus the main speaker will be able to compute the separation of the main speaker and one of the other speakers. The same procedure can be followed by a second speaker and the main speaker, and between this second speaker and a third speaker, and so on. A profile of the distance of the speakers from each other can be used to center the volume and assign the stereo channels.

Where the speakers are needed outdoors and where no AC mains are available, extension cords can be used to distribute the speakers, which can then communicate to establish balance, and control. Further, the speakers may have the ability to carry a battery power supply with AC mains recharge capability where a user needs the speakers to operate for a finite time in a non-powered environment. In the non-powered environment, communication would be by electromagnetic radio link or infra red optical link. Again, the speaker system would measure relative distance and adjust the volumes to a geometric average, based upon speaker spacing.

The speaker units may naturally have a different drive based upon speaker size, and the bass versus treble adjustment may also be made automatically, along with the volume and delay. The delay adjustment enables the master or main speaker, as well as other speaker to output a delayed audio signal likely to reach the listener at the same time as sound from a remote speaker. The delay is based upon the time required to transmit the signal from the master or main speaker to the most distant speaker and the time of audio propagation from the most distant speaker and the main speaker to a middle point. Assuming that the users was mid-way in between, the main speaker might delay its signal by the amount of time the signal takes to propagate either through the AC mains, or electromagnetically by direct radio transmission or by visual infrared. It may be expected that the transmission through the household AC mains may require a longer time period where inductance or capacitance may be encountered.

An off center balancing system may also be provided where a user activates a trigger on the speaker nearest the user. Such a trigger can instruct the automatic system to begin to shift the center of balance in the direction of that speaker, typically by lowering its volume balance and raising proportionately the volume balances of the other speakers to shift the balance center toward the speaker triggered. This shifting may be reversed by simply pressing another button to re-balance the speakers automatically.

The ability of the user to override the speaker system's automatic features will enable a quick customization to an in-depth level. Otherwise, the AC mains quick-connect and disconnect ability will allow users to quickly re-configure their speaker system by simply unplugging any of the speakers and taking them to another room for re-connection.

Another method for balance would synergize with a remote control. The user's use of the remote control at a location would be “read” by two or more speakers to establish the balance at the location of the remote control transmitter. The remote control unit may use electromagnetic communications with the other speakers.

The speaker system enables a user to set up the entire system of 4-5 speakers by simply pulling them out of a container and plugging them around the AC mains outlets in a room, and turning them on. The automatic balancing and distribution center can balance the complete room in a matter of seconds. This enables any location to be set up for area listening in just a moment or two.

### BRIEF DESCRIPTION OF THE DRAWINGS

The invention, its configuration, construction, and operation will be best further described in the following detailed description, taken in conjunction with the accompanying drawings in which:

FIG. 1 is a plan view of a main speaker controller system with AM/FM radio and a series of input buttons, along with a liquid crystal display;

FIG. 2 is a view looking into the left side of the main speaker controller system seen in FIG. 1 and illustrating a power output section, a signal input section, and one blade of a male AC mains connector;

FIG. 3 is a plan view of the rear side of the main speaker and controller seen in FIGS. 1 & 2 and illustrating a preferred location for batteries and the height of the AC mains plug;

FIG. 4 is a block diagram of one possible realization for the electronic internals of the main speaker and controller seen in FIGS. 1-3;

FIG. 5 is a perspective view of one realization of a small remote speaker;

FIG. 6 is a block diagram of a simplified version of a simplified console which may be realized in either an immovable unit or in a remote control; and

FIG. 7 is a block diagram of a simplified version of a remote speaker such as the one seen in FIG. 5.

### DETAILED DESCRIPTION OF THE PREFERRED EMBODIMENT

A speaker system may include a master speaker and controller 21. The main speaker and controller 21 has a housing 23 having a liquid crystal display 25. The realization illustrated will utilize a button input format for simplicity and the ability for all-weather operation, but other realizations are possible, such as might utilize dials and knobs, etc.

A button 31 may be a mode button 31 which enables the user to switch between an automatic, electromagnetic conductive wave through the AC mains, electromagnetic space wave through an antenna, or infrared direct line of sight communications.

A button 33 may be a remote speaker status button 33 which enables the liquid crystal display 25 to display an identity indication of all of the speakers currently in communication with the main speaker and controller 21, along with their distances from main speaker and controller 21 and distances from each other. Internal processor may enable a physical diagram of the speakers associated with the Main speaker and controller 21 to be illustrated in a geometric pattern.

Where the pattern is not exact due to error or obstruction, a user knowing the real distances could program in an override distance which may be programmed to calibrate the internal time or intensity factors used to measure both distance and balance intensity.

Button 35 may be a system volume increase button while button 37 may be a system volume decrease button. A button 39 may be a system initialization button which instructs the polling, characterization, location and measurement of other parameters of speakers associated with the main speaker and controller 21.

Button 41 may be a channel selection mode which enables manual channels to be assigned to specific ones of the other speakers (not yet shown) for the purpose of assigning different channels to different speakers. This puts a specified channel of communication into specified associated speakers. Further, where the distribution of the other speakers is over a wide area, remote from the main speaker and controller 21 a particular channel can be associated with other speakers. In a wide ranging distribution, a remote speaker may be inhibited from receiving audio feedback with the main speaker and controller 21, and manual selection of a channel may be necessary. For example, it may be difficult or impossible to select a channel within a mode in which the least noise occurs.

Button 43 may be an input selector which associates an input with a particular speaker or set of speakers. Single association between an input and a remote speaker can further facilitate a distributed association of multiple signals to separate locations. Ideally a device such as a main speaker and controller 21 can have its own internal radio as an input, as well as other ported inputs. A main speaker and controller 21 may preferably have stereo jacks, phono jacks and other input connections so that it can be used as a speaker. Further, for use with portable electronics such as compact disc players, the main speaker and controller 21 may have a power supply output to help power such devices. For example, a 3.0 volt direct current powered compact disk player could derive power from a power supply through a jumpered connection to the main speaker and controller 21.

The main speaker and controller 21 can have a level of controlled input ranging from a personal computer with a full alpha numeric keyboard to a simple device with only a few inputs. For the a small size main speaker and controller 21 and small number of inputs, it may be preferably to provide a ten digit numerical keyboard 45 which has some alpha numeric capability.

Other control buttons may include a power on/off button 47, a left cursor movement button 49 and a right cursor movement button 51. Buttons 49, 51, 35 and 37 can be used to move a cursor around on the liquid crystal display 25. A button 53 can be used to enable battery operation. Some circuits which invoke the battery when the AC mains shuts off, can deplete the battery from either the battery having to power the switch apparatus, or from unintended power outages. Where the batteries are internal and re-chargeable, the power from the AC mains can be used to re-charge the batteries.

A button 55 can be used for speaker selection. The main speaker and controller 21 shown has a larger speaker 57 and a smaller speaker 59. In the alternative, a bass and treble control from the liquid crystal display 25 can balance the amount of power to the speakers 57 and 59 to control the bass and treble. The buttons 31-43, numerical keypad 45 and buttons 47-55 can be used, along with the liquid crystal display 25 to provide more than adequate control of the main speaker and controller 21.

An optic transduction port 61 has the ability to transmit and receive electromagnetic light energy, such as infrared light energy. The size of the optic transduction port 61 may help enable a higher sensitivity. Ideally since the master speaker and controller 21 is likely to be placed anywhere and not just in a focussed line of site relationship with other speaker units (not yet shown), and the larger the reception window and the more intense the modulated infrared light source, the greater probability for communication. Further where the master speaker and controller 21 has the ability for several different modes of communication, the channels within the modes of communication will be conserved. Conservation can be made by a heuristic ordering clearest channels when full power is available, to an ordering of the most energy efficient channels when power is unavailable.

A microphone 63 can be utilized to receive audio signals which can help the master speaker and controller 21 to optimize its volume balance. By sending a pop or ping noise through speaker 59 and computing the time for a return signal from a controlled speaker unit (not yet shown), commands for balance can be generated to be applied to both the master speaker and controller 21 and one or more of the controlled speaker units remote to master speaker and controller 21.

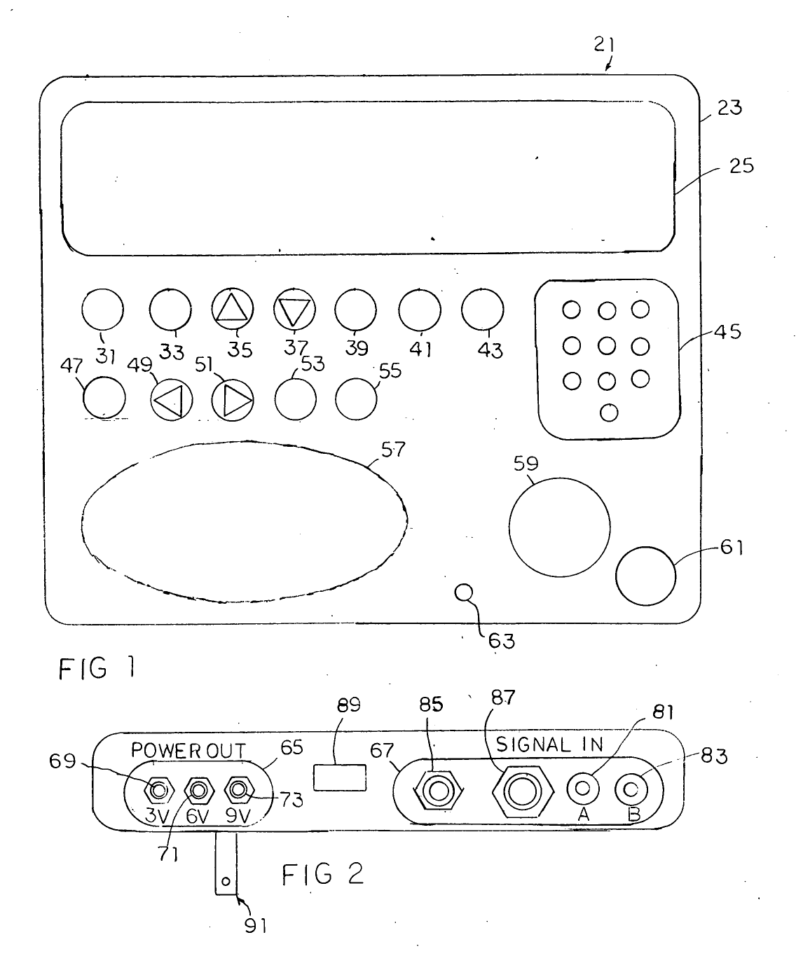

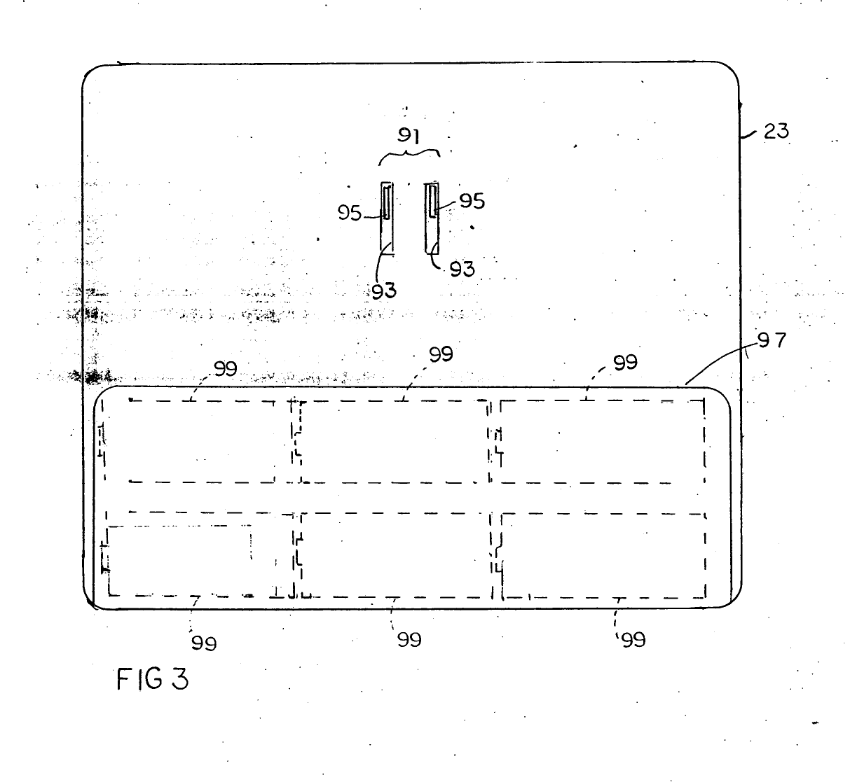

Referring to FIG. 2, a view looking into the left side of the main speaker and controller 21 seen in FIG. 1 illustrates a “power out” grouping of female connectors 65 and a “signal in” group of female connectors 67. Within the “power out” grouping of female connectors 65 is a three volt connector 69, six volt connector 71, and a nine volt connector 73. These types of connectors will work along with an extension cord set having a pair of male connectors, one end to fit within the female connectors 69, 71, and 73, with the other end to fit within the female power connector of the compact disk player, other small radio, television or other power signal input. In this manner, the main speaker and controller 21 is used as a battery saver.

A “signal in” group of connectors 67 includes phono jack inputs 81 and 83 which are used to input a pair of audio input signals. The double male ended phono jack connector sets are well known and popular available in various lengths for use with stereo and television equipment. Two jacks or inputs 81 and 83, labeled “A” and “B” inputs, respectively, enable the main speaker and controller 21 to accept a stereo signal. In terms of the mode of transmission, two channels will typically be used to transmit one channel to one speaker and another channel to another speaker where two speakers are used. Where only one speaker is used, such as where the main speaker and controller 21 is used by itself, and no other speakers are sensed, the internal signals from the phono jacks 81 and 83 will either be mixed to mono, or output separately from speakers 57 and 59.

The “signal in” group of female connectors 67 also includes a smaller jack input 85 and a larger jack input 87, typically used with three conductor connectors which can also input a two channel stereo signal. The key to the main speaker and controller 21 is the provision of high utility for the user, and the provision of a clean side profile seen in FIG. 1, along with the “power out” grouping of female connectors 65 and “signal in” group of female connectors 67 provides a device in which the user can have as a clean, neat household appliance, and yet give users the capability of making other input connections.

FIG. 2 also illustrates a male AC mains connector 91, of which one blade is seen. Male AC mains connector 91 is located relatively high with respect to the housing 21 of the main speaker and controller 21 seen in FIG. 1, in order to stabilize the support for the housing 23 from frictional contact in an AC mains female outlet. One of the ideal locations for the main speaker and controller 21 would be an AC power mains connector located about 4-5 feet from floor level so that it can be placed comfortably within view for facilitated operations and programming. The other speakers (to be shown) will be typically located in regular outlets mounted from one to two feet higher than the floor. The male AC mains connector 91 will preferably be foldable out of sight, to facilitate storage of the main speaker and controller 21 as well as battery power applications for the main speaker and controller 21.

Referring to FIG. 3, a rear view of the master speaker and controller 21 is shown. The housing is seen to include a pair of slots 93 within which the male AC mains connector 91 can pivotably fold out for deployment and fold in for stowage. Within the slots are contact blades 95 which are preferably linked together by an insulator (not shown) so that they may pivot together without short circuit. Any mechanism can be used to help actuate the contact blades between a stowed position and a deployed position.

Also seen is a battery compartment cover 97 which is shown as encasing a number of batteries 99 shown in dashed line format. The battery compartment cover 97 will preferably have a snap and slide closure mechanism which will hold the batteries 99 secure. Note that the batteries 99 are placed at the lower end of the master speaker and controller 21 to help stabilize the gravity suspension of the master speaker and controller 21 from support derived from the male AC mains connector 91. The batteries 99 can be rechargeable utilizing power from the male AC mains connector 91.

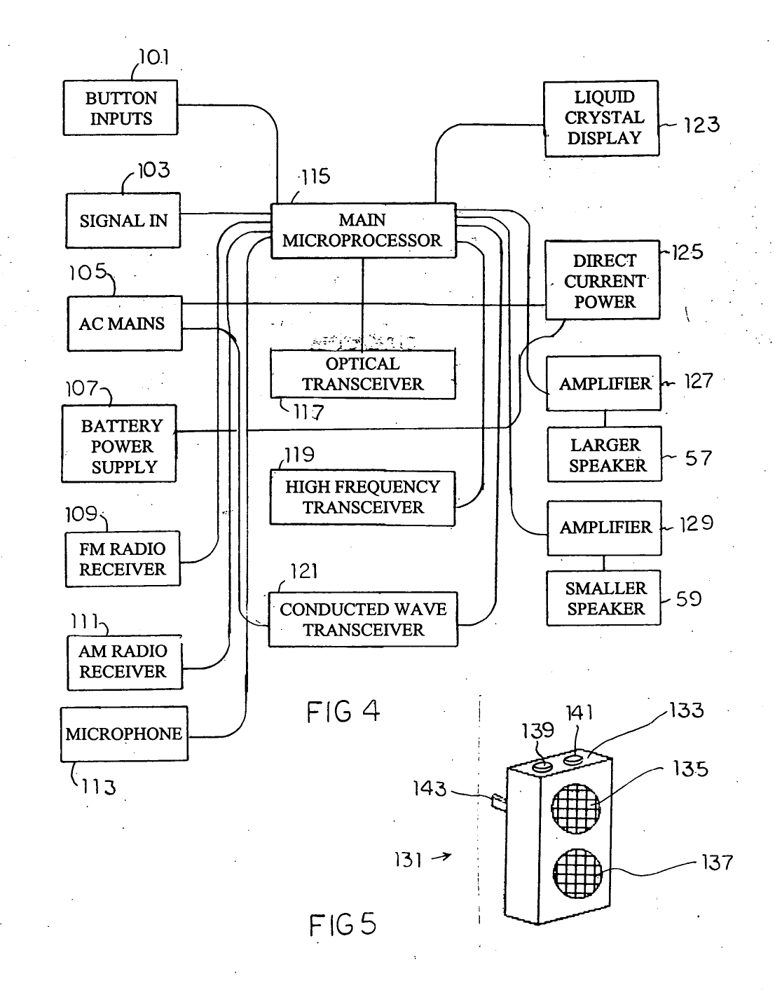

Referring to FIG. 4, a block diagram illustrates one possible realization of the internals of the master speaker and controller 21. The blocks on the left are generally inputs while the blocks on the right are generally outputs. The middle column of blocks generally have input and output capability. A BUTTON INPUTS block 101 is representative of the buttons 31-43, ten digit numerical keyboard 45, and buttons 47-55 seen in FIG. 1. In addition it also represents inputs from a remote control unit (not seen) which may include more input capability than master speaker and controller 21 or less input capability than master speaker and controller 21.

A SIGNAL IN block 103 is representative of, but not limited to, the “signal in” group of female connectors 67 seen in FIG. 2. The SIGNAL IN block 103 can include any other inputs, internal or external which the master speaker and controller 21 can use to send through to other speaker sets located within its optical, high frequency radio or other frequency conducted wave transmission and reception system. As seen in FIG. 2, external jacks 81, 93, 85, & 87 can be used to facilitate the introduction of these signals.

An AC MAINS block 105 may be the AC mains structure 91 seen in FIGS. 2 and 3, or any other manner of providing a connection to a source of AC power especially on an AC power network having other outlets into which other speaker sets (not shown) can be connected. A BATTERY POWER SUPPLY 107 may include the batteries 99 seen in FIG. 3, or any other form of energy storage device which will enable master speaker and controller 21 to operate when not receiving power from the AC mains.

An FM RADIO RECEIVER block 109 is representative of a broadcast band or satellite radio receiver within the master speaker and controller 21 and preferably operable via the buttons 31-43, ten digit numerical keyboard 45, and buttons 47-55 seen in FIG. 1, and in conjunction with the liquid crystal display 23 seen in FIG. 1. In this configuration, the master speaker and controller 21 carries its own FM radio system, eliminating the need for a user to supply an FM radio audio input signal. The same is true for an FM RADIO RECEIVER block 111 which is representative of a broadcast band radio receiver within the master speaker and controller 21 and also preferably operable via the buttons 31-43, ten digit numerical keyboard 45, and buttons 47-55 seen in FIG. 1, in conjunction with the liquid crystal display 23 seen in FIG. 1.

A MICROPHONE block 113 may include the microphone 63 seen in FIG. 1, or some other microphone structure. The MICROPHONE block 113 is utilized to help compute the distance of other speaker units (not yet shown) as well as another master speaker and controller 21.

The center column includes a MAIN MICROPROCESSOR block 115 which is configured and programmed to enable operation of all of the blocks shown in FIG. 4 and any structures seen in FIGS. 1-3. The main microprocessor works in conjunction with the buttons 31-43, ten digit numerical keyboard 45, and buttons 47-55 seen in FIG. 1, in conjunction with the liquid crystal display 23 seen in FIG. 1 to enable an operator to control the function of the master speaker and controller 21 and all smaller sub-system speaker units associated with it. It is also programmed to seek out and identify any others of the master speaker and controller 21 within communication range. Where two such master speaker and controller 21 units are available in communication with each other, the operator can either set one of the other master speaker and controller 21 units to operate as a sub-system speaker, relinquishing control to one designated by the user to be the master control master speaker and controller 21.

In the alternative, where two master speaker and controller 21 systems are connected to the same AC mains system or are within communication with each other and where it is desired to keep them separate, the MAIN MICROPROCESSOR block 115 can be programmed to avoid use of the same communications channels. In this manner, two master speaker and controller 21 units can operate in the same communicative range or on the same AC mains system and not interfere with each other. The priority between the two master speaker and controller 21 units can be set by handshake, or a time shared hand-off priority in which the first priority is had by a first master speaker and controller 21 for a first time period and then handed to a second master speaker and controller 21 during a second time period.

The Microprocessor in the MAIN MICROPROCESSOR block 115 is responsible for polling, channel selection, transmission and reception of polling and identity signals and all automatic functions. It can be controlled to enable the user to manually specify any of the functions that it performs automatically.

An OPTICAL TRANSCEIVER block 117 is connected to the MAIN MICROPROCESSOR block 115. OPTICAL TRANSCEIVER block 117 includes a light detector, light source and digital signal converter. The MAIN MICROPROCESSOR block 115 may operate the OPTICAL TRANSCEIVER block 117 in real time or through a dedicated transducer. The master speaker and controller 21 can utilize the OPTICAL TRANSCEIVER block 117 to both transmit information, control data, and an audio stream to, as well as receive identity information and verification signals from another speaker unit (not yet shown), or another master speaker and controller 21.

A HIGH FREQUENCY TRANSCEIVER block 119 is connected to the MAIN MICROPROCESSOR block 115. HIGH FREQUENCY TRANSCEIVER block 119 preferably includes a high frequency radio transmitter and receiver, at a frequency preferably higher than 900 MHZ. Higher frequencies have a greater possibility of propagating through a building structure without reduced interference. Further, this mode will preferably take over any time that either the conducted wave or optical modes suffer failure. This will likely occur whenever something causes a major amount of noise in the AC mains system or when physical blockage of the optic transduction port 61 with respect to other speaker units.

A CONDUCTED WAVE TRANSCEIVER block 121 is connected to the MAIN MICROPROCESSOR block 115. CONDUCTED WAVE TRANSCEIVER block 121 will preferably include a medium frequency radio transmitter and receiver, as well as the ability to test the impedance of the AC mains to determine the best propagating frequency. Since a MAIN MICROPROCESSOR block 115 is utilized along with other filtering components found in the CONDUCTED WAVE TRANSCEIVER block 121, a frequency can be selected based both upon the natural impedance of the AC mains wiring, and the noise factor. For a given noise factor which is equal across all frequencies, the frequency which better matches the impedance of the AC mains wiring will propagate more efficiently. In addition, CONDUCTED WAVE TRANSCEIVER block 121 may also include an impedance matching network which will enable the MAIN MICROPROCESSOR block 115 to receive a reflected signal to optimize control of the matching network for optimum transmission. The master speaker and controller 21 can also then send messages to controlled speaker assemblies (not yet shown) to have them communicate over a mode, channel and frequency which is optimum for the AC mains system.

Further, AC mains communication does not have the line of sight limitations for infrared optic energy propagation, and will enable communication through buildings which would otherwise remain impenetrable to high frequency electromagnetic frequencies. Even a vault, or Faraday cage would not prevent communication so long as there is an AC mains.

The MAIN MICROPROCESSOR block 121 can assist in helping to tune the CONDUCTED WAVE TRANSCEIVER by the use of an echo function. The MAIN MICROPROCESSOR block 121 can send signals over one channel to return over another, or it can command a remote speaker assembly (not yet shown) to record a short transmission and return it over the same channel to test the noise level.

A LIQUID CRYSTAL DISPLAY block 123 can be the liquid crystal display 25 of FIG. 1, or a computer screen, lap top, or other visual display. Where computer data port 89 is connected to a computer, the computer can become an expanded version of the liquid crystal display 25 and can be used to provide an expanded, facilitated programming opportunity. The LIQUID CRYSTAL DISPLAY block 123 represents any sort of programmer interface structure.

A DIRECT CURRENT POWER block 125 is shown connected to the AC MAINS block 105 and is shown outputting a direct current to the BATTERY POWER SUPPLY block 107. The DIRECT CURRENT POWER block 125 is also directly connected to power the FM RADIO RECEIVER block 109, AM RADIO RECEIVER block 111, MAIN MICROPROCESSOR block 115, OPTICAL TRANSCEIVER block 117, HIGH FREQUENCY TRANSCEIVER block 119, CONDUCTED WAVE TRANSCEIVER block 121, & LIQUID CRYSTAL DISPLAY block 123, even though the connections are not shown in order to help keep the block diagram of FIG. 4 cleaner and more free of connection lines. Where the power to any block in FIG. 4 needs to pass through further filtering, or further regulation, power may be derived from any other block as shared or made more securely available.

An AMPLIFIER block 127 is connected to MAIN PROCESSOR block 115 and to the LARGER SPEAKER 57 seen in FIG. 1. Likewise, An AMPLIFIER block 129 is connected to MAIN PROCESSOR block 115 and to the SMALLER SPEAKER 59 seen in FIG. 1.

Referring to FIG. 5, one embodiment of a remote speaker 131 is seen. Remote speaker 131 may have a housing 133 including a first speaker 135 and a second speaker 137. Two speakers 135 and 137 may differ in size in order to facilitate an expanded audio frequency capability. A first upper control 139 may act as a volume control, to enable a local user to override control of the main speaker and controller 21 and thus provide a local override of the volume. A second upper control 141 may provide other features such as treble/bass, an intercom feature to communicate throughout the system which includes remote speakers 131, and main speaker and controller 21. Also seen is a male AC mains connector 143 which may be similar and function the same as male AC mains connector 91.

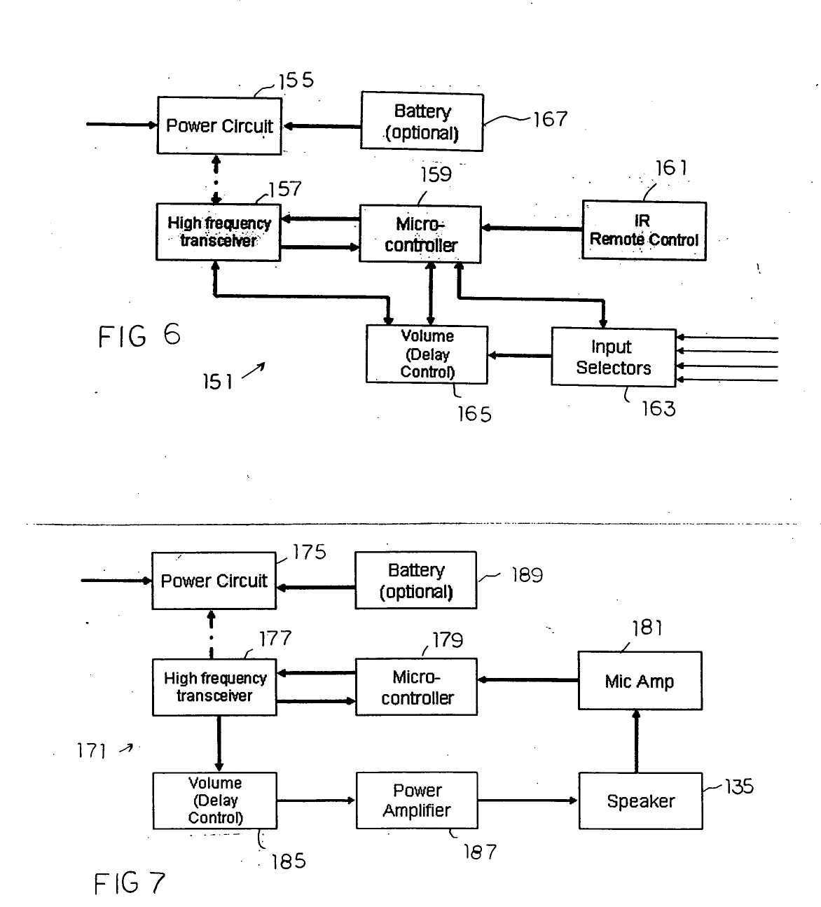

Referring to FIG. 6, an alternative, simplified block diagram for a simplified console 151, similar to main speaker and controller 21, but lacking a main speaker. A console 151 can occupy a physical space ranging from a stereo receiver for a more encompassing display, to a simple, hand-held remote-type control. In the latter case, the user can control and adjust all of the components of the speaker system, regardless of its size and complexity. This is particularly desirable where the user can remotely adjust the individual remote speakers 131 sound level to match the user's location in a room.

A POWER CIRCUIT block 155 supplies power and include a male AC mains connector 91. A HIGH FREQUENCY TRANSCEIVER block 157 may transmit to the POWER CIRCUIT block 155 to input and output electromagnetic signals. HIGH FREQUENCY TRANSCEIVER block 157 may be in communications with a MICRO CONTROLLER block 159 and may provide for any mode of control for the HIGH FREQUENCY TRANSCEIVER block 157, such as direct digital control, or frequency synthesis within the MICROCONTROLLER block 159 where the HIGH FREQUENCY TRANSCEIVER block 157 may simply provide a traffic control function. Because digital control is had, the possibility for spread spectrum techniques are facilitated.

MICROCONTROLLER block 159 may be connected to an IR REMOTE CONTROL block 161, especially where simplified console 151 is at a fixed location and where a smaller, possibly hand held control can be used to operate the simplified console 151. The MICROCONTROLLER block 159 may be connected to an INPUT SELECTOR block 163 which may accept input from controls on a housing of the simplified console 151, from a remote speaker 131 through the AC mains, or electromagnetically by radio wave. The INPUT SELECTOR block 163 may act to communicate with the MICROCONTROLLER block 159, or with a VOLUME (DELAY CONTROL) block 165. VOLUME (DELAY CONTROL) block 165 is also in communication with the MICROCONTROLLER block 159 and the HIGH FREQUENCY TRANSCEIVER block 157.

A BATTERY (OPTIONAL) block 167 is shown connected to the POWER CIRCUIT block 155. The A BATTERY (OPTIONAL) block 167, may be a series of batteries for power backup, or for use where an operating AC mains may not be available. In the alternative, the simplified console 151 may itself operate as a remote control, especially where the it is configured to operate as a hand held device. In such case, the IR REMOTE CONTROL block 161 would be unnecessary. When not connected to the AC mains, simplified console 151 would need to communicate and control the remote speakers 131 by means other than a conducted wave sent through the AC mains. With the BATTERY (OPTIONAL) block 167, the POWER CIRCUIT block 155 may also be used to power the simplified console 151, recharge the batteries, and to allow self-contained self-powered operation.

Referring to FIG. 7, an alternative, simplified block diagram for a simplified remote speaker system 171, which may or may not be similar to the remote speaker 131, is shown. A remote speaker system 171 can be as small as a one or two cubic inches, or as large as several cubic feet. In any event, the user of the simplified console 151 or main speaker and controller 21 should be able to control the user can control and adjust all of the components of the speaker system, including the simplified remote speaker system 171 possibly subject to local control. A good example of a situation where the simplified console 151 or main speaker and controller 21 could enable local volume control for some uses might include a music system for distribution throughout an office or warehouse for playing background music. A user would have the capability of controlling the background music level, but for an announcement, the local control may be overridden so that the regardless of its size and complexity. This is particularly desirable where the user can remotely adjust the individual remote speakers 131 sound level to match the user's location in a room. This is just one configuration for a simplified remote speaker system 171.

A POWER CIRCUIT block 175 supplies power and may include a male AC mains connector 91. A HIGH FREQUENCY TRANSCEIVER block 177 may transmit to the POWER CIRCUIT block 175 to input and output electromagnetic signals. HIGH FREQUENCY TRANSCEIVER block 177 may be in communications with a MICROCONTROLLER block 179 and may provide for any mode of control for the HIGH FREQUENCY TRANSCEIVER block 177, such as direct digital control, or frequency synthesis within the MICROCONTROLLER block 179 where the HIGH FREQUENCY TRANSCEIVER block 177 may simply provide a traffic control function, in the same manner as was shown for the simplified console 151. Again, where digital control is had, the possibility for spread spectrum techniques are facilitated.

MICROCONTROLLER block 179 may be connected to a MIC AMP block 181 which may be in turn connected to the speaker 135 which was seen in FIG. 5. This is the case where the speaker can be used either as a microphone or with its operation coordinated with a microphone, so as to silence the speaker when the microphone of the MIC AMP block 181 is operated. The HIGH FREQUENCY TRANSCEIVER block 177 may be connected to a VOLUME (DELAY CONTROL) block 185. VOLUME (DELAY CONTROL) block 185 is also in communication with a POWER AMPLIFIER block 187, which is in turn connected to the speaker 135.

A BATTERY (OPTIONAL) block 189 is shown connected to the POWER CIRCUIT block 175. The A BATTERY (OPTIONAL) block 189, may be a series of batteries for power backup, or for use where an operating AC mains may not be available. In this case, the simplified remote speaker system 171 would need to communicate and control the remote speakers 131 by means other than a conducted wave sent through the AC mains. With the BATTERY (OPTIONAL) block 189, the POWER CIRCUIT block 175 may also be used to power the simplified remote speaker system 171, recharge the batteries, and to allow self-contained self-powered operation.

While the present invention has been described in terms of a distributed speaker system with a main speaker and controller, and in which a variety of features are available, including the ability to add speaker sets controlled by the main speaker and controller with automatic balancing, built in radio, easy access user inputs and utility direct current power, the present invention may be applied in any situation where the ease and utility of the combined structures are desired to increase the utility of use of a component add-on speaker system.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A controller comprising:
a main housing;
a microprocessor;
a status indicator connected to said microprocessor;
a plurality of controls for user selectable control connected to said microprocessor;
an AC mains connector for connecting said main controller to a conventional alternating current receptacle and for supporting said main housing from said conventional alternating current receptacle; and
a conducted wave transmitter connected to said microprocessor and to said AC mains connector, for transmitting a signal to a remote speaker.

2. The main controller as recited in claim 1 and further comprising an electromagnetic space wave transmitter for use when an operating AC mains is not available to said AC mains connector.

3. The main controller as recited in claim 1 and further comprising an infrared receiver for receiving remote control from a remote control with an infrared transmitter.

4. The main controller as recited in claim 1 and further comprising at least one of a broadcast band and satellite radio receiver as a source of signal for transmission to said remote speaker.

5. The main controller as recited in claim 1 and wherein said conducted wave transmitter is a transceiver and wherein said microprocessor is programmed to electromagnetically poll at least one said remote speaker to determine its location from said main speaker and controller.

6. The main controller as recited in claim 1 and further comprising an audio receiver and wherein said microprocessor is programmed to perform an poll at least one said remote speaker to determine its location from said main speaker and controller.

7. The main controller as recited in claim 1 and further comprising a main controller speaker supported by said main housing.

8. The main controller as recited in claim 1 and further comprising a remote speaker which further comprises:
a speaker housing;
a speaker microprocessor;
an audio speaker in control communication with said speaker microprocessor;
at least one user selectable control;
an AC mains connector for connecting said remote speaker to a conventional alternating current receptacle and for supporting said remote speaker from said conventional alternating current receptacle; and
a conducted wave receiver connected to said speaker microprocessor and to said AC mains connector, for receiving a signal from said controller.

9. The main controller as recited in claim 8 and wherein said a conducted wave receiver is a transmitter to facilitate polling.

10. The main controller as recited in claim 9 and wherein said remote speaker includes a microphone connected to said speaker microprocessor, to facilitate communication from said remote speaker back to said main controller as well as to facilitate audio polling.

11. The main controller as recited in claim 8 and further comprising an electromagnetic space wave transceiver for use when an operating AC mains is not available to said AC mains connector of said remote speaker.

12. The main controller as recited in claim 8 and wherein said conducted wave transmitter is a transceiver and wherein said speaker microprocessor is encoded with a random identifier which can enable said main controller microprocessor to identify an identity of said remote speaker.

13. The main controller as recited in claim 7 and further comprising a remote speaker which further comprises:
a speaker housing;
a speaker microprocessor;
an audio speaker in control communication with said speaker microprocessor;
at least one user selectable control connected to at least one of said audio speaker and said speaker microprocessor;
a speaker microphone connected to said speaker microprocessor;
an AC mains connector for connecting said remote speaker to a conventional alternating current receptacle and for supporting said remote speaker from said conventional alternating current receptacle; and
an electromagnetic receiver connected to said speaker microprocessor for receiving a signal, and wherein said speaker controller is programmed to adjust an audio output volume of said audio speaker in response to an audio volume output of said main controller speaker to provide automatic audio balancing.

14. a remote speaker which comprises:
a speaker housing;
a speaker microprocessor;
an audio speaker in control communication with said speaker microprocessor;
at least one user selectable control connected to at least one of said audio speaker and said speaker microprocessor;
a speaker microphone connected to said speaker microprocessor;
an AC mains connector for connecting said remote speaker to a conventional alternating current receptacle and for supporting said remote speaker from said conventional alternating current receptacle; and
an electromagnetic receiver connected to said speaker microprocessor for receiving a signal, and wherein said speaker controller is programmed to adjust an audio output volume of said audio speaker in response to an audio volume output of at least one other remote speaker to provide automatic audio balancing.
